(19) United States
(12) Patent Application Publication
(10) Pub. No.: US 2024/0270200 A1
(43) Pub. Date: Aug. 15, 2024

(54) BUCKLE DEVICE

(71) Applicant: KABUSHIKI KAISHA TOKAI-RIKA-DENKI-SEISAKUSHO, Aichi-ken (JP)

(72) Inventor: Ryuji YAMAGUCHI, Aichi (JP)

(73) Assignee: KABUSHIKI KAISHA TOKAI-RIKA-DENKI-SEISAKUSHO, Aichi-ken (JP)

(21) Appl. No.: 18/441,620

(22) Filed: Feb. 14, 2024

(30) Foreign Application Priority Data
Feb. 15, 2023 (JP) 2023-022013

(51) Int. Cl. B60R 22/28; B60R 22/18; B60R 22/26

(52) U.S. Cl. CPC B60R 22/28; B60R 22/26; B60R 2022/1806; B60R 2022/281; B60R 2022/286

(57) ABSTRACT

In a buckle device, a wire harness is connected to a buckle body, and the wire harness is mounted to a mounting plate of a boot. Therefore, in a case in which, at the time of light collision of a vehicle, tension is applied to a belt to extend the belt, and the buckle body is extended upward, the mounting plate is elastically bent, and the upward movement of the wire harness is allowed. Accordingly, it is possible to suppress disconnection of the wire harness.

### CROSS-REFERENCE TO RELATED APPLICATION

This application is based on and claims priority under 35 USC 119 from Japanese Patent Application No. 2023-22013 filed on Feb. 15, 2023, the disclosure of which is incorporated by reference herein.

### BACKGROUND

### Technical Field

The present invention relates to a buckle device in which a coupling member is coupled to a buckle body.

### Related Art

In the buckle device disclosed in Japanese Patent Application Laid-Open (JP-A) No. 2020-125010, a webbing is coupled to a buckle body, and tension is applied from the buckle body to the webbing to extend the webbing, thereby extending the buckle body.

Here, in the buckle device, in a case in which a wiring is electrically connected to the buckle body, it is preferable that disconnection of the wiring can be suppressed in a case in which the buckle body is extended.

### SUMMARY

In view of such circumstances, an object of the invention is to obtain a buckle device capable of suppressing disconnection of a wiring in a case in which a buckle body is extended.

According to a first aspect of the invention, a buckle device includes a buckle body configured to engage with a tongue provided at a webbing attached to an occupant; a coupling member that is coupled to the buckle body and is extended by tension applied from the buckle body to extend the buckle body; a support member that supports the buckle body and is provided with a mounting part; and a wiring that is electrically connected to the buckle body, is mounted to the mounting part, the mounting part being elastically deformed and allowing the wiring to move in a case in which the buckle body is extended.

In the buckle device in the first aspect of the invention, the buckle body is configured to engage with the tongue provided at the webbing attached to the occupant. The coupling member is coupled to the buckle body, and the coupling member is extended by tension applied from the buckle body to the coupling member, whereby the buckle body is extended. The support member supports the buckle body, and the wiring is electrically connected to the buckle body.

Here, the wiring is mounted to the mounting part of the support member, and in a case in which the buckle body is extended, the mounting part is elastically deformed, and the wiring is allowed to move. Therefore, it is possible to suppress disconnection of the wiring.

In a buckle device according to a second aspect of the invention, in the buckle device according to the first aspect of the invention, the mounting part is elongated.

In the buckle device according to the second aspect of the invention, the mounting part is elongated. Therefore, it is possible to easily and elastically deform the mounting part.

In a buckle device according to a third aspect of the invention, in the buckle device according to the first or second aspect of the invention, a slack is provided at a part of the wiring between the buckle body and the mounting part.

In the buckle device according to the third aspect of the invention, the slack is provided at the part of the wiring between the buckle body and the mounting part. Therefore, in a case in which the buckle body is extended, the wiring can be moved due to the slack, and it is possible to further suppress the disconnection of the wiring.

In a buckle device according to a fourth aspect of the invention, in the buckle device according to any one of the first to third aspects of the invention, the mounting part is provided at a part of the support member on an inner side or an outer side in the vehicle width direction.

In the buckle device according to the fourth aspect of the invention, the mounting part is provided at the part of the support member on the inner side or the outer side in the vehicle width direction. Therefore, the mounting part can be elastically deformed in the vehicle width direction.

A buckle device according to a fifth aspect of the invention in the buckle device according to any one of the first to fourth aspects of the invention further includes an extension part that is configured to extend from the support member and is adjacent to the mounting part.

In the buckle device according to the fifth aspect of the invention, the extension part is configured to extend from the support member, and the extension part is adjacent to the mounting part. Therefore, it is possible to restrict touching of an occupant with the wiring by the extension part.

In a buckle device according to a sixth aspect of the invention, in the buckle device according to any one of the first to fifth aspects of the invention, rigidity of a proximal-end side part of the mounting part is higher than rigidity of a distal-end side part of the mounting part, and the wiring is mounted to the distal-end side part of the mounting part.

In the buckle device of the sixth aspect of the invention, the rigidity of the proximal-end side part of the mounting part is higher than the rigidity of the distal-end side part of the mounting part, and the wiring is mounted to the distal-end side part of the mounting part. Therefore, since the mounting part is elastically deformed at the proximal-end side part, it is possible to increase an elastic restoring force of the proximal-end side part of the mounting part.

A buckle device according to a seventh aspect of the invention in the buckle device according to any one of the first to sixth aspects of the invention further includes a deformation member that is deformed in a case in which an extension load on the buckle body is equal to or more than a predetermined load, and allows the buckle body to extend.

In the buckle device according to the seventh aspect of the invention, the deformation member is deformed in a case in which the extension load on the buckle body is equal to or more than the predetermined load, and the buckle body is allowed to extend. Therefore, it is possible to reduce a load applied to the occupant from the webbing, and to protect the occupant.

### BRIEF DESCRIPTION OF THE DRAWINGS

Exemplary embodiments of the present invention will be described in detail based on the following figures, wherein:

FIG. 1 is a right side view illustrating a buckle device according to a first embodiment of the invention as viewed from a right;

FIG. 2A is a perspective view illustrating the buckle device according to the first embodiment of the invention as viewed from a diagonally front right;

FIG. 2B is a perspective view illustrating the buckle device according to the first embodiment of the invention as viewed from a diagonally front left;

FIG. 3 is a cutaway view illustrating the buckle device according to the first embodiment of the invention as viewed from the right;

FIG. 4A is a perspective view illustrating the buckle device according to the first embodiment of the invention as viewed from the diagonally front right;

FIG. 4B is a perspective view illustrating the buckle device according to the first embodiment of the invention as viewed from a diagonally rear right;

FIG. 5A is a perspective view illustrating the buckle device according to the first embodiment of the invention as viewed from a diagonally rear left;

FIG. 5B is a bottom view illustrating the buckle device according to the first embodiment of the invention as viewed from a bottom;

FIG. 6A is a perspective view illustrating the buckle device according to the first embodiment of the invention as viewed from a rear side;

FIG. 6B is a rear view illustrating the buckle device according to the first embodiment of the invention as viewed from a rear;

FIG. 7 is a perspective view illustrating the buckle device according to the first embodiment of the invention at time of light collision of a vehicle as viewed from the diagonally rear right;

FIG. 8A is a perspective view illustrating a buckle device according to a second embodiment of the invention as viewed from the diagonally front right;

FIG. 8B is a perspective view illustrating the buckle device according to the second embodiment of the invention as viewed from the diagonally rear right;

FIG. 9A is a perspective view illustrating the buckle device according to the second embodiment of the invention as viewed from the diagonally rear left;

FIG. 9B is a bottom view illustrating the buckle device according to the second embodiment of the invention as viewed from the bottom;

FIG. 10A is a perspective view illustrating the buckle device according to the second embodiment of the invention as viewed from the rear side;

FIG. 10B is a rear view illustrating the buckle device according to the second embodiment of the invention as viewed from the rear;

FIG. 11A is a perspective view illustrating a buckle device according to a third embodiment of the invention as viewed from the diagonally front right;

FIG. 11B is a perspective view illustrating the buckle device according to the third embodiment of the invention as viewed from the diagonally rear right;

FIG. 12A is a perspective view illustrating the buckle device according to the third embodiment of the invention as viewed from the diagonally rear left;

FIG. 12B is a bottom view illustrating the buckle device according to the third embodiment of the invention as viewed from the bottom;

FIG. 13A is a perspective view illustrating the buckle device according to the third embodiment of the invention as viewed from the rear side;

FIG. 13B is a rear view illustrating the buckle device according to the third embodiment of the invention as viewed from the rear;

FIG. 14 is a right side view illustrating a buckle device according to a fourth embodiment of the invention as viewed from the right;

FIG. 15A is a right side view illustrating a main part of the buckle device according to the fourth embodiment of the invention as viewed from the right;

FIG. 15B is a right side view illustrating the buckle device according to the fourth embodiment of the invention at time of light collision of a vehicle as viewed from the right;

FIG. 15C is a perspective view illustrating the buckle device according to the fourth embodiment of the invention at the time of the light collision of the vehicle as viewed from the diagonally rear right;

FIG. 16A is a rear view illustrating a boot of a buckle device according to a fifth embodiment of the invention as viewed from the rear;

FIG. 16B is a perspective view illustrating the boot of the buckle device according to the fifth embodiment of the invention as viewed from the rear side;

FIG. 16C is a perspective view illustrating the boot of the buckle device according to the fifth embodiment of the invention as viewed from a front side;

FIG. 17A is a perspective view illustrating the boot of the buckle device according to the fifth embodiment of the invention as viewed from a bottom side;

FIG. 17B is a rear view illustrating the boot of the buckle device according to the fifth embodiment of the invention as viewed from the rear; and

FIG. 17C is a detailed perspective view illustrating the boot of the buckle device according to the fifth embodiment of the invention as viewed from the rear side.

### DETAILED DESCRIPTION

### First Embodiment

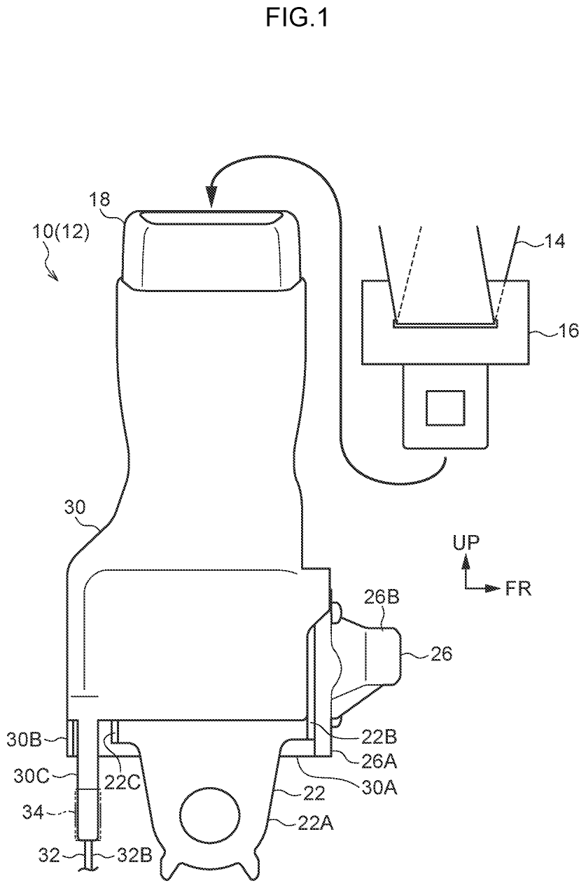

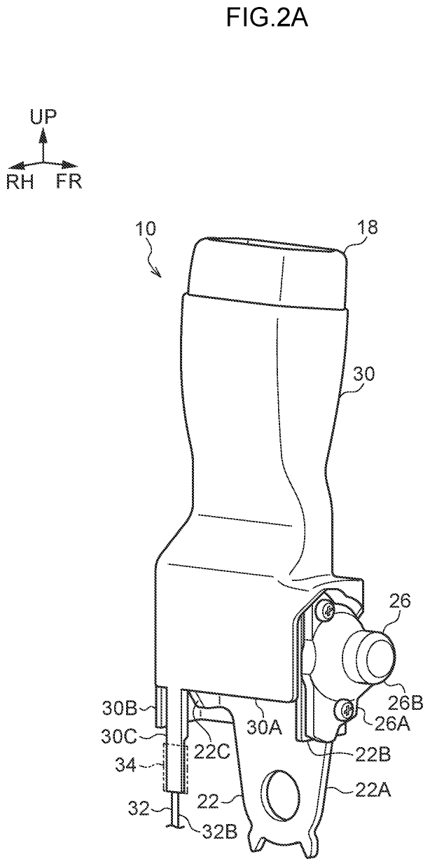

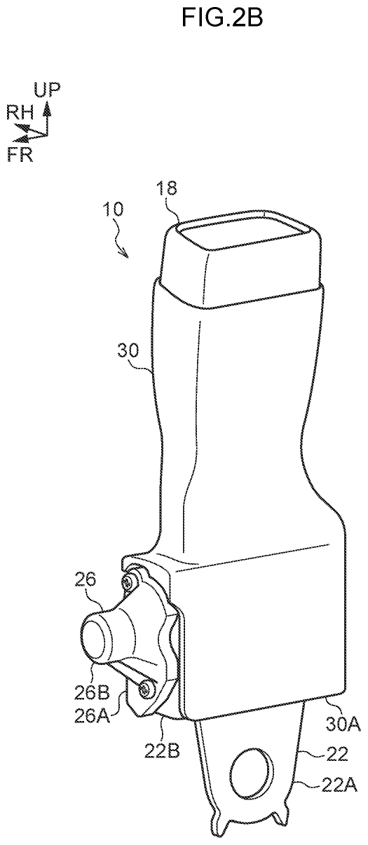

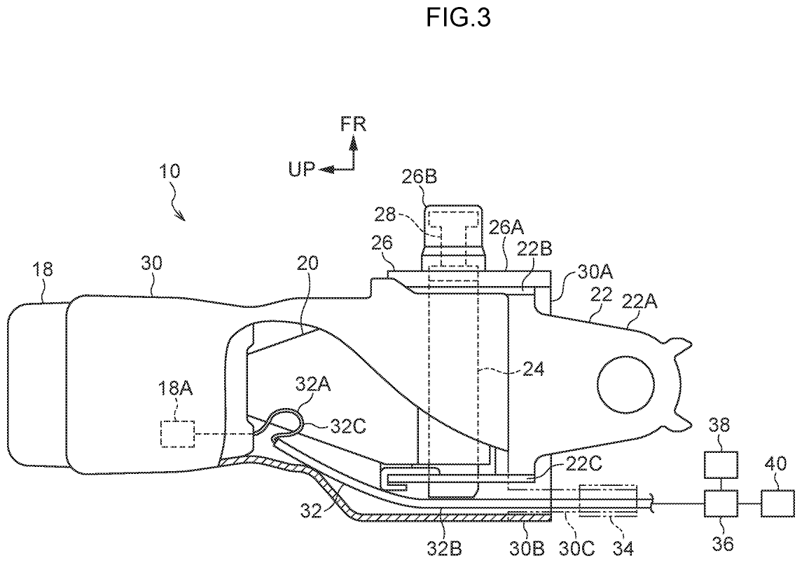

FIG. 1 is a right side view illustrating a buckle device 10 according to a first embodiment of the invention as viewed from the right. FIG. 2A is a perspective view illustrating the buckle device 10 as viewed from the diagonally front right. FIG. 2B is a perspective view illustrating the buckle device 10 as viewed from the diagonally front left. FIG. 3 is a cutaway view illustrating the buckle device 10 as viewed from the right. In the drawings, the front of the buckle device 10 is indicated by an arrow FR, the right (obverse side) of the buckle device 10 is indicated by an arrow RH, and the upper side of the buckle device 10 is indicated by an arrow UP.

The buckle device 10 according to the present embodiment constitutes a seat belt device 12 of a vehicle (automobile). The seat belt device 12 is applied to a seat (not illustrated) in a vehicle interior. The seat belt device 12 is provided with a winding device (not illustrated). The winding device is installed on the vehicle width direction outer side and the lower side of a seat rear part. In the winding device, a webbing 14 (see FIG. 1) having a long band shape is wound from the proximal end side. A webbing 14 is biased to the winding side to the winding device and pulled out upward from the winding device. The winding device is provided with a lock mechanism, and the lock mechanism locks pulling-out of the webbing 14 from the winding device in an emergency of the vehicle (in collision or the like).

The webbing 14 passes through a through anchor (not illustrated) movably on the distal end side with respect to the winding device. The through anchor is installed on the vehicle width direction outer side and the upper side of the seat rear part. An anchor (not illustrated) is fixed to the distal end part of the webbing 14, and the anchor is installed on the vehicle width direction outer side and the lower side of the seat rear part. The webbing 14 movably passes through a tongue 16 (see FIG. 1) between the through anchor and the anchor.

The buckle device 10 is installed on the vehicle width direction inner side and the lower side of the seat rear part. The front, the right, and the upper side of the buckle device 10 are directed toward the diagonally front bottom, directed inward in the vehicle width direction, and directed toward the diagonally front top, respectively.

As illustrated in FIGS. 1, 2A, and 2B, a buckle body 18 having a substantially rectangular parallelepiped shape is provided at an upper part of the buckle device 10. The tongue 16 is engageable with the buckle body 18 from the upper side. The tongue 16 is engaged with the buckle body 18, and the webbing 14 is attached to an occupant seated on the seat. As a result, a part (shoulder webbing) of the webbing 14 between the through anchor and the tongue 16 is stretched obliquely from the shoulder part to the waist part (including the chest part) of the occupant, and a part (wrap webbing) of the webbing 14 between the tongue 16 and the anchor is stretched laterally to the waist part of the occupant. The engagement of the tongue 16 with the buckle body 18 is releasable. The engagement of the tongue 16 with the buckle body 18 is released to release the attachment of the webbing 14 to the occupant. The lower side part of the buckle body 18 gradually becomes smaller downward in the right-left direction.

A buckle switch 18A (see FIG. 3) as a detection unit is provided in the buckle body 18. The buckle switch 18A detects the engagement of the tongue 16 with the buckle body 18 and detects the attachment of the webbing 14 to the occupant. A plurality of buckle switches 18A may be provided.

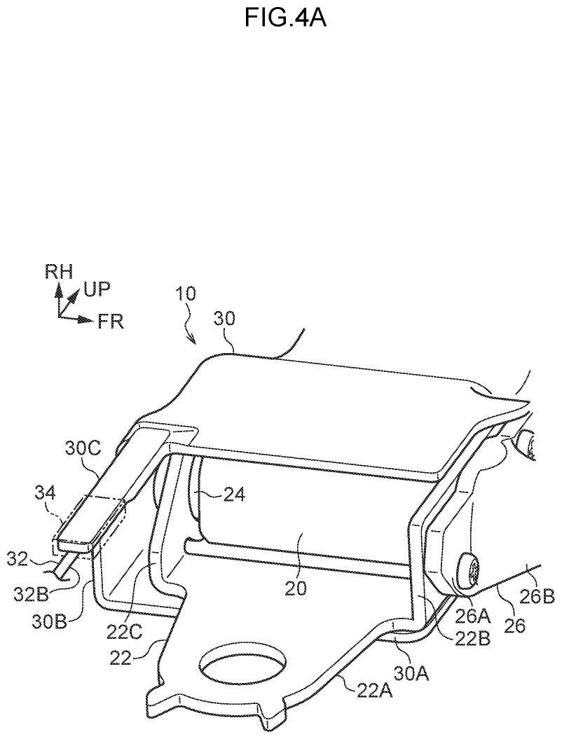

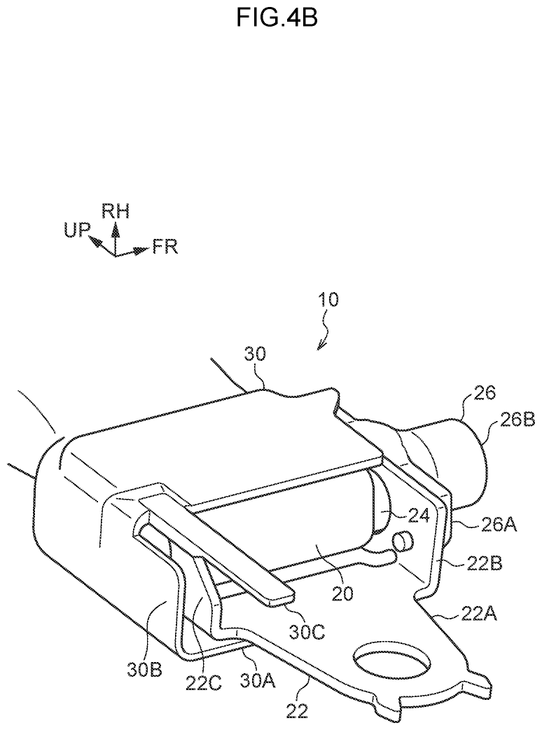

As illustrated in FIGS. 3, 4A, and 4B, a distal-end side part (upper side part) of a band-shaped belt 20 (webbing) as a coupling member is coupled to the lower part of the buckle body 18. The belt 20 is made of, for example, the same material as the material of the webbing 14 and made into a woven fabric.

A frame 22 made of metal as a support is provided in a lower part of the buckle device 10, and the frame 22 is made to have a U-shaped plate shape in a cross section. A back plate 22A is provided at a left part of the frame 22. The frame 22 is fixed to a vehicle body side (for example, a rear part of a seat lower part) at a lower end part of the back plate 22A. Leg plates 22B and 22C are provided at the front part and the rear part of the frame 22, respectively. The leg plates 22B and 22C protrude rightward from the back plate 22A.

A spool 24 that is made of metal and has a substantially cylindrical shape as a winding shaft passes through the leg plates 22B and 22C of the frame 22. The spool 24 is supported by the frame 22. The axial direction of the spool 24 is parallel to the front-rear direction, and the spool 24 is made rotatable about the central axis. A proximal-end side part (lower side part) of the belt 20 is coupled to the spool 24. The belt 20 is wound around the spool 24 and pulled out upward from the left side of the spool 24.

A case 26 that is made of metal as a locking body is disposed on the front side of the frame 22 (leg plate 22B). The case 26 is provided with a regulation plate 26A that has a substantially rectangular plate shape as a restriction part. The regulation plate 26A is fixed to the leg plate 22B, and thus the case 26 is fixed to the leg plate 22B. A locking cylinder 26B having a substantially bottomed cylindrical shape is integrally formed on the front side of the regulation plate 26A. The axial direction of the locking cylinder 26B is parallel to the front-rear direction. The inside of the locking cylinder 26B penetrates the regulation plate 26A and is opened to the rear side of the regulation plate 26A. The front part of the spool 24 is coaxially inserted into the case 26.

A torsion shaft 28 that is made of metal and has a substantially circular columnar shape as a deformation member (energy absorbing member) is coaxially disposed in the case 26. The front end part of the torsion shaft 28 is locked to the front end part in the locking cylinder 26B in a relatively non-rotatable manner. The rear end part of the torsion shaft 28 is coupled to the spool 24 in a relatively non-rotatable manner to restrict the rotation of the spool 24.

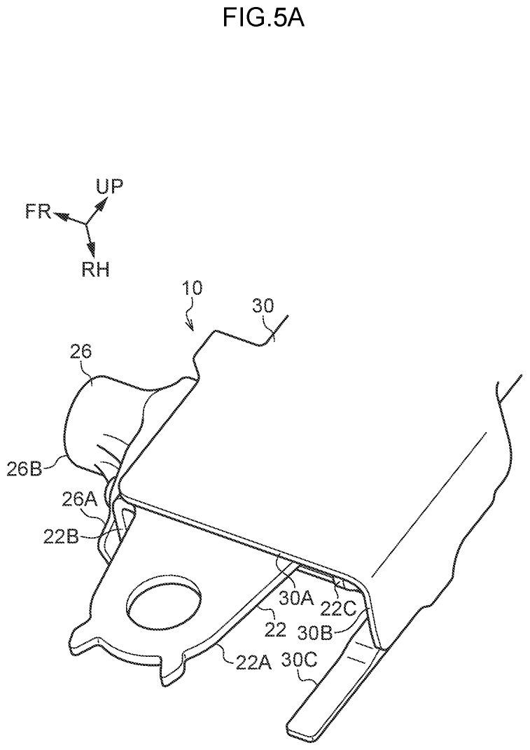

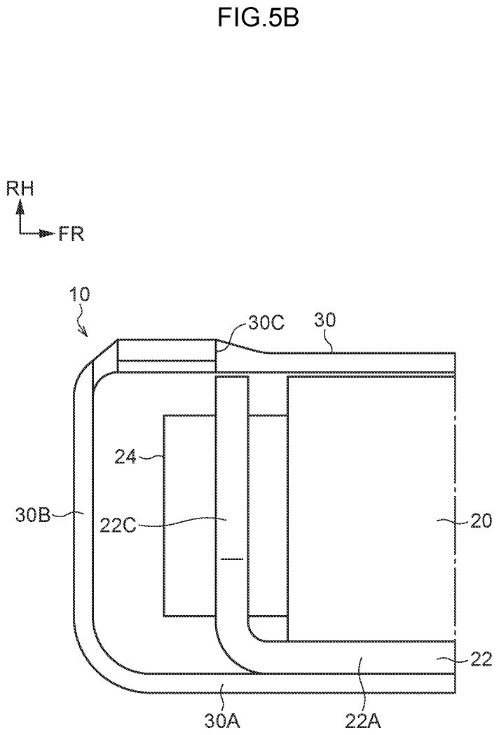

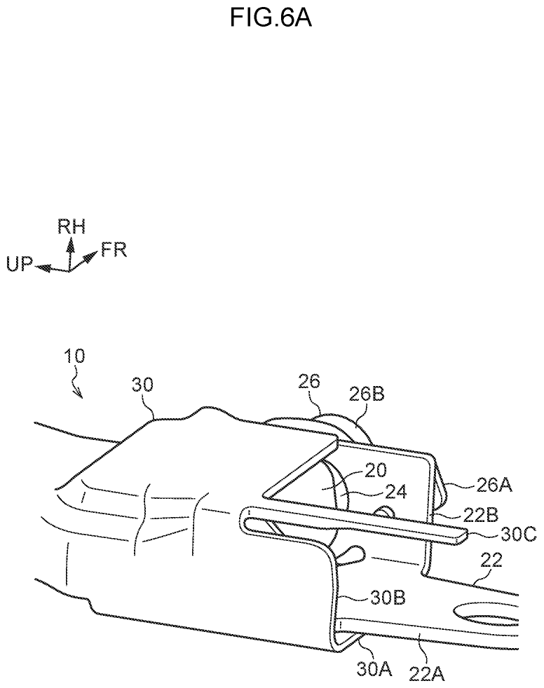

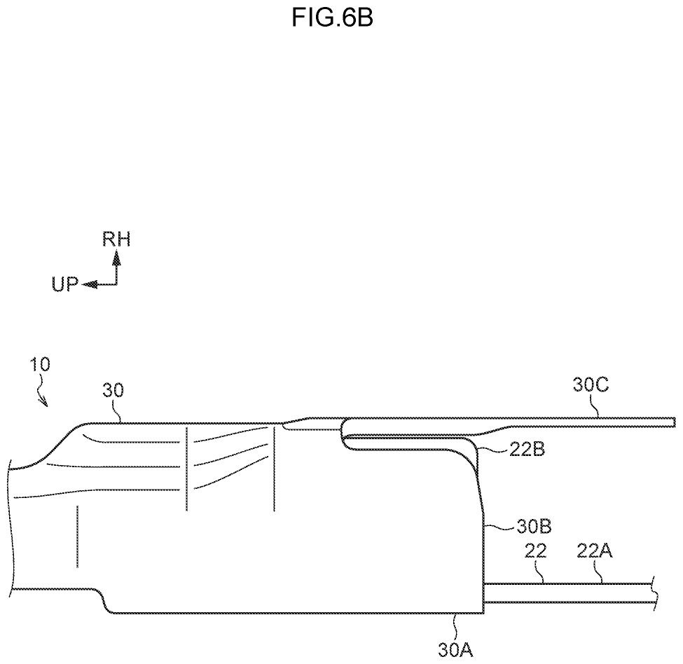

A boot 30 (see FIGS. 4A, 4B, 5A, 5B, 6A, and 6B) having a substantially rectangular cylindrical shape as a support member is provided in a range from the buckle body 18 to the frame 22. The boot 30 is made of soft resin and has flexibility (elasticity). The upper part of the boot 30 gradually becomes smaller downward in the right-left direction. The lower side part of the buckle body 18 is fitted into the upper part of the boot 30, thereby restricting the downward movement of the buckle body 18. The belt 20 is inserted into the boot 30, and the frame 22 (including the spool 24) is inserted into the lower part of the boot 30. The inside of the lower part of the boot 30 is opened to the front side, and the case 26 protrudes to the front side of the lower part of the boot 30. Just above the lower part in the boot 30 is supported by the frame 22 from the lower side, which restricts the downward movement of the boot 30. An elastic contraction force is applied to the boot 30 between the buckle body 18 and the frame 22 in a state where the belt 20 is wound around the spool 24 as described above, and thus the tension is applied to the belt 20. The boot 30 biases the frame 22 downward to be self-standing with respect to the frame 22 and biases the buckle body 18 upward to be self-standing.

The left wall and the rear wall of the boot 30 are extended downward. An extension portion of the left wall of the boot 30 is made to serve as a fixing wall 30A that has a rectangular plate shape as a fixing part, and an extension portion of the rear wall of the boot 30 is made to serve as an extension wall 30B that has a rectangular plate shape as an extension part. A clip (not illustrated) made of hard resin passes through the fixing wall 30A of the boot 30 and the back plate 22A of the frame 22. The clip sandwiches the fixing wall 30A and the back plate 22A and fixes the boot 30 to the frame 22.

A mounting plate 30C having a long plate shape as a mounting part is integrally formed at the rear end part of the right wall of the boot 30. The mounting plate 30C is made to have a rectangular cross section. The mounting plate 30C extends downward, and the mounting plate 30C is adjacent to the vicinity of the front side of an extension wall 30B of the boot 30. A thickness dimension of a proximal-end side part (upper side part) of the mounting plate 30C is larger than a thickness dimension of a distal-end side part (lower side part) of the mounting plate 30C, and a left surface of a part between the proximal-end side part and the distal-end side part of the mounting plate 30C is inclined rightward as being directed downward. Therefore, a cross-sectional coefficient of the proximal-end side part of the mounting plate 30C is larger than a cross-sectional coefficient of the distal-end side part of the mounting plate 30C, and the rigidity of the proximal-end side part of the mounting plate 30C is larger than the rigidity of the distal-end side part of the mounting plate 30C. A part of the right wall of the boot 30 in the vicinity of the mounting plate 30C is made to have a large thickness similar to the proximal-end side part of the mounting plate 30C.

The right side of the lower part (part below the spool 24) of the buckle device 10 is covered with a cloth-like cover (not illustrated), and the cover is fixed to the seat. The buckle device 10 protrudes diagonally forward and upward of the vehicle from between the seat and the cover, and the extension wall 30B of the boot 30 is exposed on the vehicle upper side between the seat and the cover.

One end of a wire harness 32 (see FIG. 3) as a wiring is electrically connected to the buckle switch 18A in the buckle body 18. The wire harness 32 is routed below the boot 30 from the lower end of the buckle body 18 through the inside of the boot 30 (including a space between the rear wall (including the extension wall 30B) of the boot 30 and the leg plate 22C of the frame 22). The wire harness 32 is provided with two (may be three or more) electric wires 32A. The electric wire 32A is made into, for example, an AVSS line (thin low-voltage electric wire for an automobile) and is provided with a sheath on the outer periphery. A vinyl tube 32B having a circular tubular shape as a covering tube is provided on the other end side from one end part of the wire harness 32, and the vinyl tube 32B has flexibility. The two electric wires 32A are inserted into the vinyl tube 32B, and the two electric wires 32A are protected by the vinyl tube 32B. For example, a U-shaped slack 32C is provided at one end part (a part of only two electric wires 32A) of the wire harness 32.

A tape 34 (adhesive tape) as a mounting member is wound around the outer periphery of the distal-end side part of the mounting plate 30C of the boot 30 and the wire harness 32. The wire harness 32 is mounted to the distal-end side part of the mounting plate 30C by the tape 34. Thus, the movement of the wire harness 32 from the inside of the boot 30 to the lower side (outer side) of the boot 30 is restricted.

The buckle switch 18A is electrically connected to a control device 36 of the vehicle via the wire harness 32. For example, an airbag device 38 and a warning device 40 of the vehicle are electrically connected to the control device 36. In a case in which the buckle switch 18A does not detect the engagement of the tongue 16 with the buckle body 18 (the attachment of the webbing 14 to the occupant), the airbag device 38 is not actuated at the time of collision of the vehicle or the warning device 40 warns the occupant to urge the attachment of the webbing 14, under the control of the control device 36. In a case in which the buckle switch 18A detects the engagement of the tongue 16 with the buckle body 18 (the attachment of the webbing 14 to the occupant), the airbag device 38 is actuated at the time of collision of the vehicle, or the warning device 40 does not warn the occupant to urge the attachment of the webbing 14, under the control of the control device 36.

Next, the action of the embodiment will be described.

In the seat belt device 12 having the above configuration, in the buckle device 10, the torsion shaft 28 restricts the rotation of the spool 24 to restrict the pulling-out of the belt 20 from the spool 24 and the upward extension of the buckle body 18, and the webbing 14 is attached to the occupant by engaging the tongue 16 of the webbing 14 with the buckle body 18.

At the time of collision of the vehicle (in emergency), the locking mechanism of the winding device locks the pulling-out of the webbing 14 from the winding device, whereby the occupant is restrained by the webbing 14. For example, in a case in which an inertial force is applied to the occupant and the webbing 14 is pulled by the occupant, a pulling force from the spool 24 is applied to the belt 20 from the webbing 14 via the tongue 16 and the buckle body 18, whereby a rotational force is applied to the spool 24.

At the time of collision other than light collision of the vehicle (for example, at the time of high-speed collision), the torsion shaft 28 is deformed to be twisted (plastically deformed) between the front end part and the rear end part by the rotational force applied to the spool 24, and the rotation of the spool 24 is allowed, so that the belt 20 is allowed to be pulled out from the spool 24 and the buckle body 18 (including the tongue 16) is allowed to extend upward. Therefore, a load applied from the webbing 14 to the occupant (particularly, the chest part) is reduced (restricted to a load (force limiter load) twisted deformation of the torsion shaft 28), and kinetic energy of the occupant is absorbed by twisted deformation of the torsion shaft 28, whereby the occupant is protected.

At the time of light collision of the vehicle (for example, at the time of low-speed collision), the torsion shaft 28 is not deformed to be twisted (plastically deformed) between the front end part and the rear end part by the rotational force applied to the spool 24, and the rotation of the spool 24 is not allowed. Tension is applied to the belt 20 by the load from the occupant to the webbing 14, the belt 20 is extended (elastically extended), and the winding part of the belt 20 around the spool 24 is fastened, whereby the buckle body 18 is extended upward by a predetermined distance. After the end of the light collision of the vehicle, the application of the tension to the belt 20 due to the load on the webbing 14 from the occupant is released, the extension of the belt 20 is released, and the winding of the winding part of the belt 20 around the spool 24 is released, whereby the buckle body 18 is moved downward and returned to an initial position.

The slack 32C is provided at one end part of the wire harness 32, and the wire harness 32 is mounted to the distal-end side part of the mounting plate 30C of the boot 30. Therefore, at the time of the light collision of the vehicle, the buckle body 18 is extended upward, and the wire harness 32 is moved integrally with the buckle body 18 upward. Thus, the slack 32C at one end part of the wire harness 32 is removed, and the wire harness 32 applies an upward moving force to the distal-end side part of the mounting plate 30C.

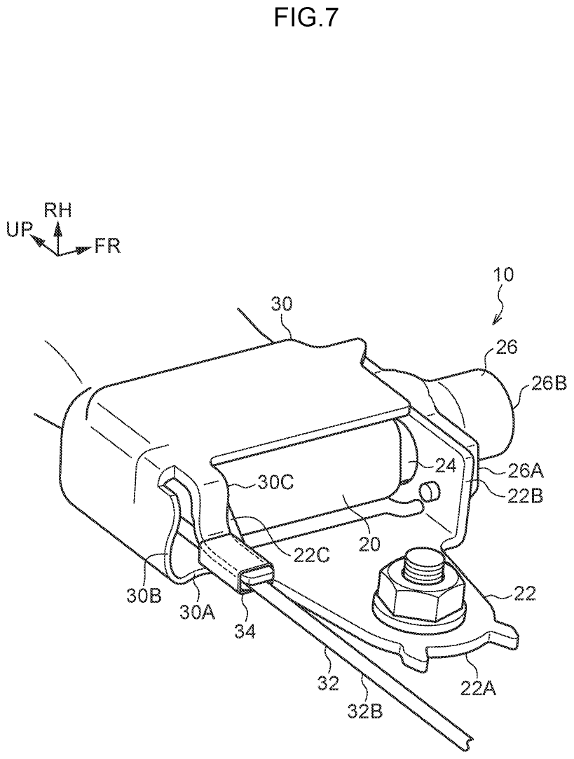

Here, in a case in which the wire harness 32 applies the upward moving force to the distal-end side part of the mounting plate 30C, the mounting plate 30C is elastically bent, and the upward movement of the wire harness 32 is allowed (see FIG. 7). Therefore, it is possible to suppress an increase in the tension applied to the wire harness 32, and to suppress disconnection of the wire harness 32.

After the end of the light collision of the vehicle, the buckle body 18 is moved downward and returned to the initial position. Thus, the mounting plate 30C is elastically restored, and the wire harness 32 is moved downward. Therefore, the wire harness 32 can be returned to the initial position, the buckle device 10 can be returned to the initial state, and the replacement of the buckle device 10 can be made unnecessary.

The mounting plate 30C is elongated. Therefore, at the time of the light collision of the vehicle, the mounting plate 30C can be easily elastically bent in the longitudinal direction, and the mounting plate 30C can easily allow the upward movement of the wire harness 32.

The slack 32C is provided at one end part of the wire harness 32. Therefore, at the time of the light collision of the vehicle, the wire harness 32 can be moved upward by the slack 32C, and thus it is possible to further suppress the disconnection of the wire harness 32. In addition, since the disconnection of the wire harness 32 can be suppressed not only by the slack 32C of the wire harness 32 but also by the elastic bending of the mounting plate 30C, it is possible to reduce the amount of the slack 32C of the wire harness 32, to suppress an occurrence of a situation in which the wire harness 32 is displaced by the slack 32C and interferes with other components, and to simplify the layout in the boot 30.

The rigidity of the proximal-end side part of the mounting plate 30C is larger than the rigidity of the distal-end side part of the mounting plate 30C. In a case in which the mounting plate 30C is elastically bent, an intermediate part of the proximal-end side part of the mounting plate 30C is bent while the proximal-end side end part of the distal-end side part of the mounting plate 30C is bent (see FIG. 7). Therefore, after the end of the light collision of the vehicle, it is possible to increase the elastic restoring force against the bending of the proximal-end side part of the mounting plate 30C, to favorably move the wire harness 32 downward, and to favorably return the wire harness 32 to the initial position.

In addition, the rigidity of the distal-end side part of the mounting plate 30C is smaller than the rigidity of the proximal-end side part of the mounting plate 30C. Therefore, in a case in which the mounting plate 30C is elastically bent, it is possible to increase the bending amount of the proximal-end side end part of the distal-end side part of the mounting plate 30C and to suppress an occurrence of a situation in which the distal-end side part of the mounting plate 30C and the wire harness 32 are tilted to the left side of the proximal-end side part of the mounting plate 30C.

Further, the mounting plate 30C is provided on the inner side (right side) of the boot 30 in the vehicle width direction. Therefore, the mounting plate 30C can be elastically deformed in the vehicle width direction of the boot 30 (the inner side of the boot 30 in the embodiment).

The extension wall 30B of the boot 30 is disposed on the vehicle upper side (rear side) of the mounting plate 30C and the wire harness 32. Therefore, it is possible to restrict touching of the occupant with the wire harness 32 by the extension wall 30B at the normal time of the vehicle.

At the time of the light collision of the vehicle, the amount of upward movement of the wire harness 32 due to the slack 32C at the one end part of the wire harness 32 is larger than the amount of upward movement of the wire harness 32 due to the elastic bending of the mounting plate 30C. Therefore, at the normal time of the vehicle, the tension of the webbing 14 applied to the buckle body 18 is smaller than the tension at the time of the light collision of the vehicle, and the disconnection of the wire harness 32 is suppressed by the slack 32C of the wire harness 32. Thus, it is possible to suppress the elastic bending of the mounting plate 30C, which is performed an excessive number of times.

In the embodiment, the thickness of the entire proximal-end side part of the mounting plate 30C in a width direction is larger than the thickness of the distal-end side part of the mounting plate 30C. The thickness of a part of the proximal-end side part of the mounting plate 30C in the width direction may be larger than the thickness of the distal-end side part of the mounting plate 30C. Even in this case, it is possible to efficiently increase the cross-sectional coefficient of the proximal-end side part of the mounting plate 30C and to efficiently increase the rigidity of the proximal-end side part of the mounting plate 30C.

### Second Embodiment

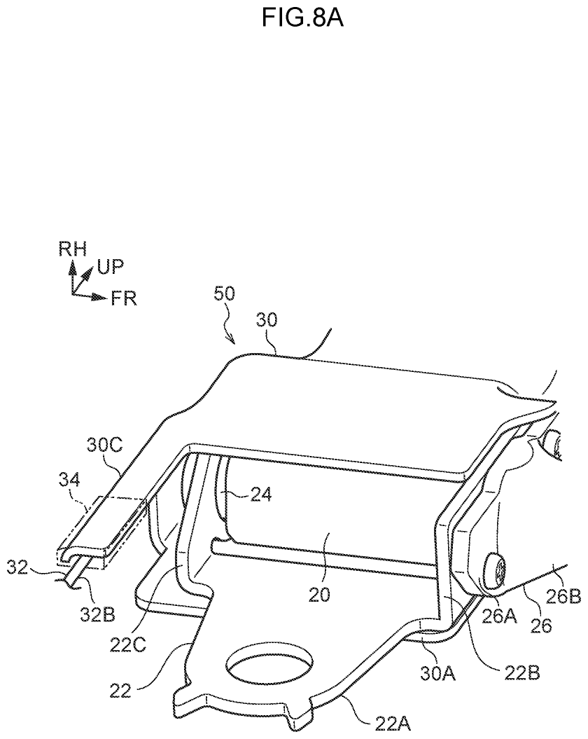

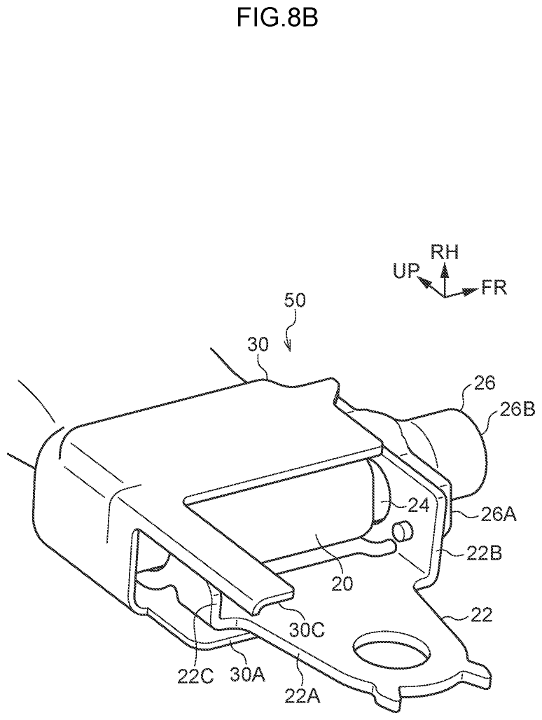

FIG. 8A is perspective view illustrating a buckle device 50 according to a second embodiment of the invention as viewed from the diagonally front right. FIG. 8B is a perspective view illustrating the buckle device 50 as viewed from the diagonally rear right.

The buckle device 50 according to the present embodiment has substantially the similar configuration to the configuration of the first embodiment, but differs in the following points.

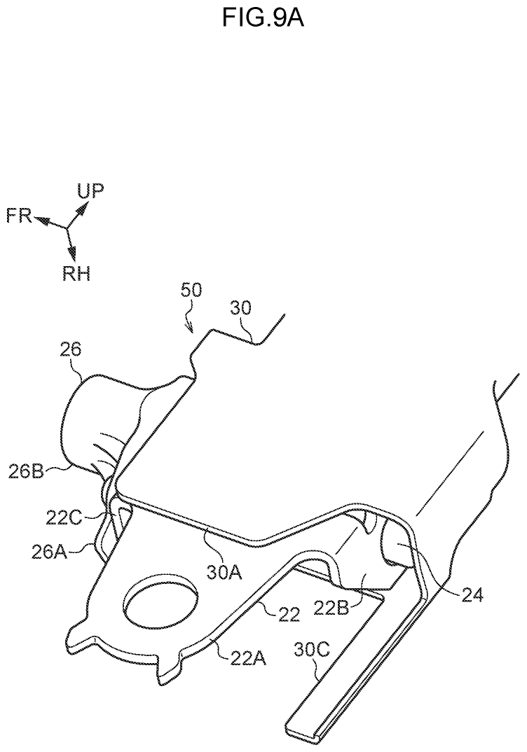

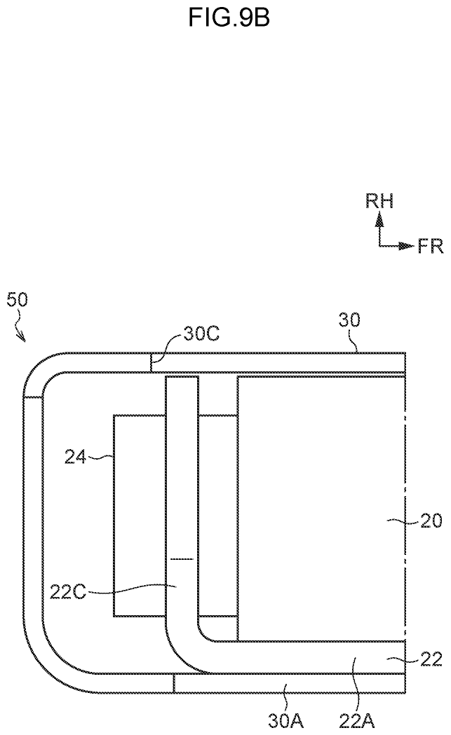

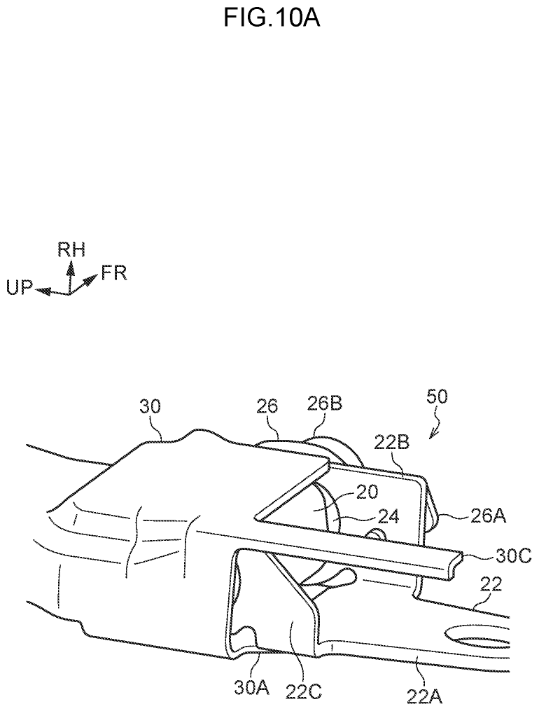

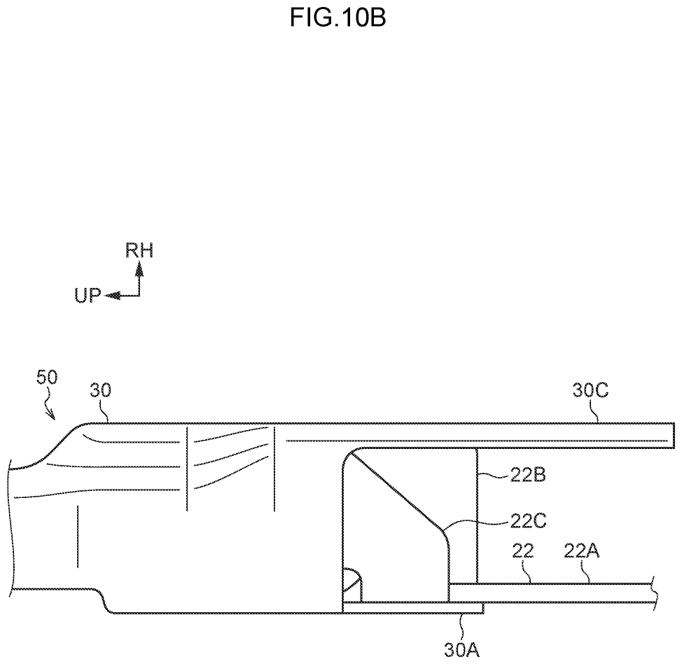

As illustrated in FIGS. 8A, 8B, 9A, 9B, 10A, and 10B, in the buckle device 50 according to the embodiment, a boot 30 is not provided with an extension wall 30B.

In the boot 30, the thickness dimension of the proximal-end side part (upper side part) of a mounting plate 30C is not larger (made the same) than the thickness dimension of the distal-end side part (lower side part) of the mounting plate 30C, and the thickness of a part of the right wall of the boot 30 in the vicinity of the mounting plate 30C is not made larger. The mounting plate 30C is made to have an L-shaped cross section. The rear end part of the mounting plate 30C protrudes leftward and is integrated with the rear wall of the boot 30. Therefore, the cross-sectional coefficient of the proximal-end side part of the mounting plate 30C and the cross-sectional coefficient of the distal-end side part of the mounting plate 30C are large, and the rigidity of the proximal-end side part of the mounting plate 30C and the rigidity of the distal-end side part of the mounting plate 30C are large.

In a case in which, at the time of light collision of a vehicle, a wire harness 32 is moved upward integrally with a buckle body 18, and the mounting plate 30C is elastically bent, the intermediate part of the proximal-end side part of the mounting plate 30C is bent while the proximal-end side end part of the distal-end side part of the mounting plate 30C is bent.

Here, also in the embodiment, it is possible to exhibit the actions and effects similar to those of the first embodiment except for the action and effect obtained by making the rigidity of the distal-end side part of the mounting plate 30C smaller than the rigidity of the proximal-end side part of the mounting plate 30C and the action and effect obtained by the extension wall 30B of the boot 30.

In the embodiment, the cross-sectional coefficient of the distal-end side part of the mounting plate 30C is equal to the cross-sectional coefficient of the proximal-end side part of the mounting plate 30C, and the rigidity of the distal-end side part of the mounting plate 30C is equal to the rigidity of the proximal-end side part of the mounting plate 30C. The cross-sectional coefficient of the distal-end side part of the mounting plate 30C may be smaller than the cross-sectional coefficient of the proximal-end side part of the mounting plate 30C, and the rigidity of the distal-end side part of the mounting plate 30C may be smaller than the rigidity of the proximal-end side part of the mounting plate 30C.

### Third Embodiment

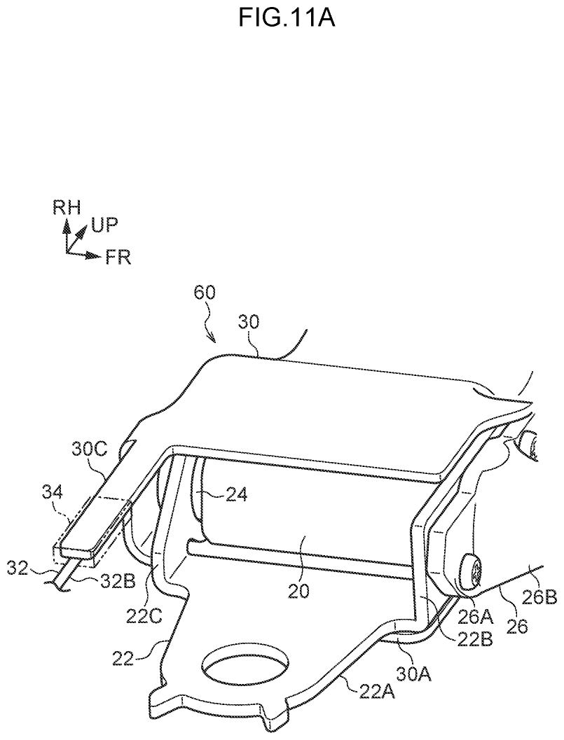

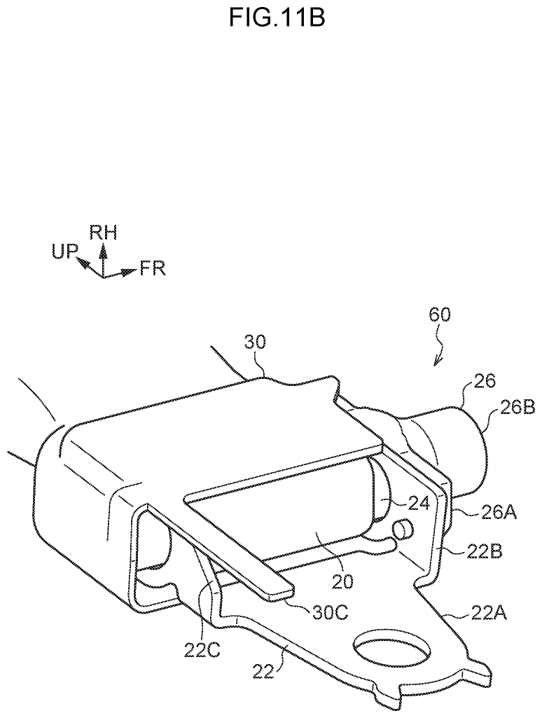

FIG. 11A is perspective view illustrating a buckle device 60 according to a third embodiment of the invention as viewed from the diagonally front right. FIG. 11B is a perspective view illustrating the buckle device 60 as viewed from the diagonally rear right.

The buckle device 60 according to the present embodiment has substantially the similar configuration to the configuration of the first embodiment, but differs in the following points.

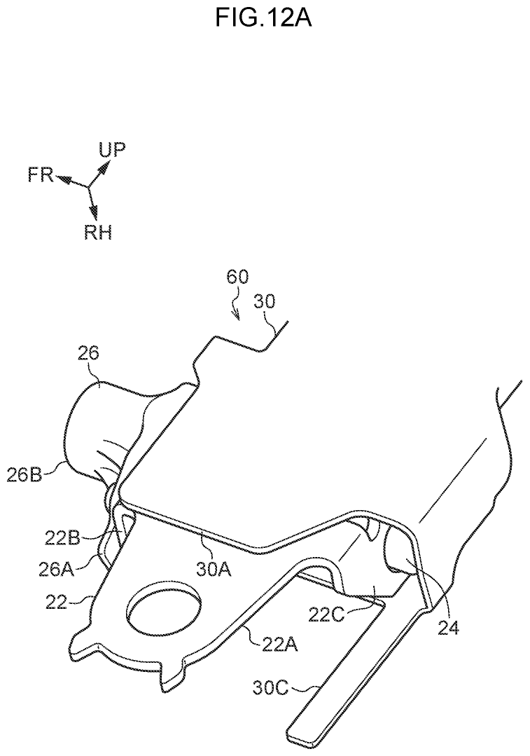

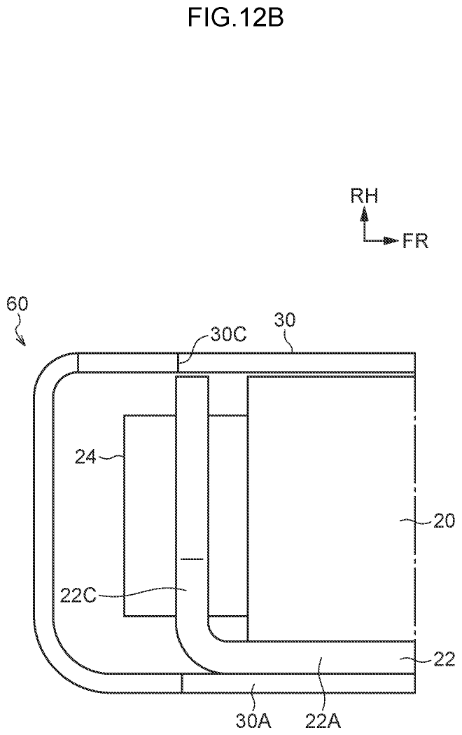

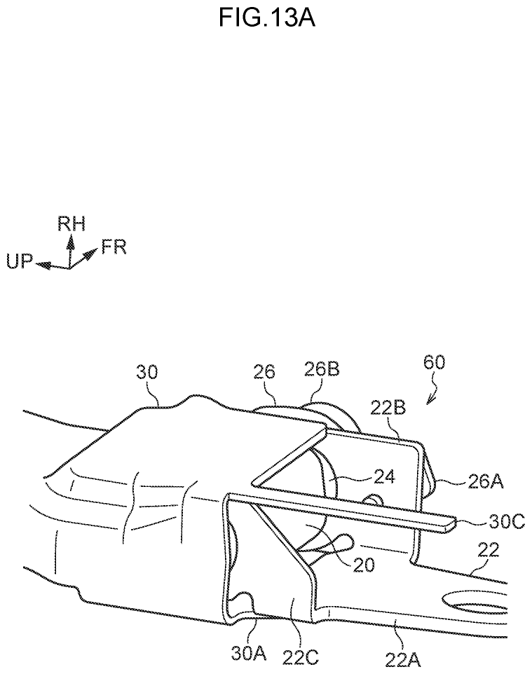

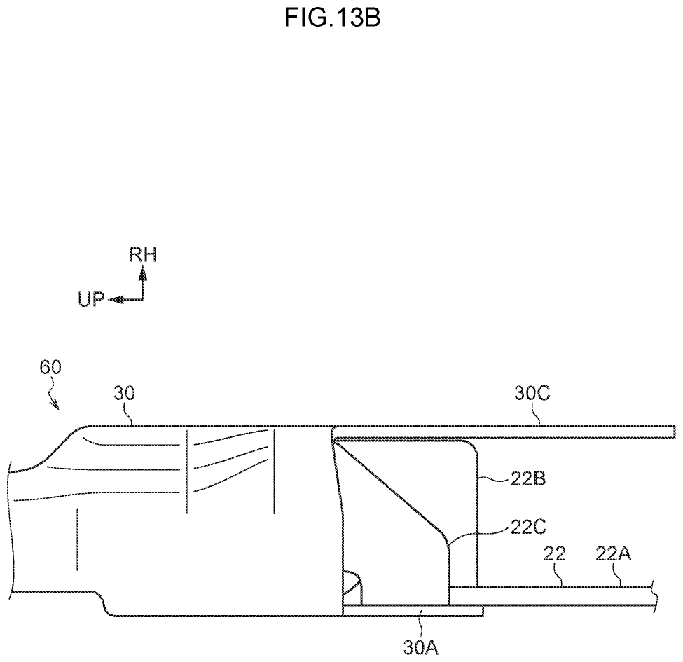

As illustrated in FIGS. 11A, 11B, 12A, 12B, 13A, and 13B, in the buckle device 60 according to the embodiment, a boot 30 is not provided with an extension wall 30B.

In the boot 30, the thickness dimension of the proximal-end side part (upper side part) of a mounting plate 30C is not larger (made the same) than the thickness dimension of the distal-end side part (lower side part) of the mounting plate 30C, and the thickness of a part of the right wall of the boot 30 in the vicinity of the mounting plate 30C is not larger. Therefore, the cross-sectional coefficient of the proximal-end side part of the mounting plate 30C and the cross-sectional coefficient of the distal-end side part of the mounting plate 30C are small, and the rigidity of the proximal-end side part of the mounting plate 30C and the rigidity of the distal-end side part of the mounting plate 30C are small.

In a case in which, at the time of light collision of a vehicle, a wire harness 32 is moved upward integrally with a buckle body 18, and the mounting plate 30C is elastically bent, the intermediate part of the proximal-end side part of the mounting plate 30C is bent while the proximal-end side end part of the distal-end side part of the mounting plate 30C and the proximal end part of the mounting plate 30C are bent.

Here, also in the embodiment, it is possible to exhibit the actions and effects similar to those of the first embodiment except for the action and effect obtained by making the rigidity of the proximal-end side part of the mounting plate 30C larger than the rigidity of the distal-end side part of the mounting plate 30C and the action and effect obtained by the extension wall 30B of the boot 30.

In the second embodiment and the third embodiment, the boot 30 is not provided with the extension wall 30B. The boot 30 may be provided with the extension wall 30B.

In the first to third embodiments, the mounting plate 30C is provided inside the boot 30 in the vehicle width direction. The mounting plate 30C may be provided outside the boot 30 in the vehicle width direction.

### Fourth Embodiment

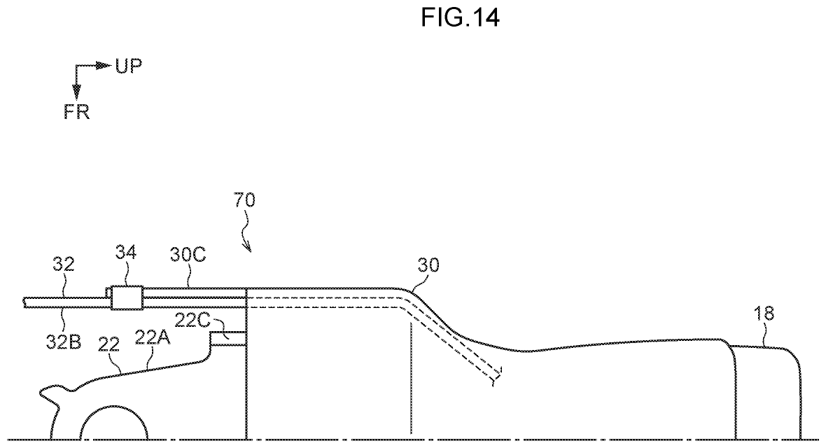

FIG. 14 is a right side view illustrating a buckle device 70 according to a fourth embodiment of the invention as viewed from the right.

The buckle device 70 according to the present embodiment has substantially the similar configuration to the configuration of the first embodiment, but differs in the following points.

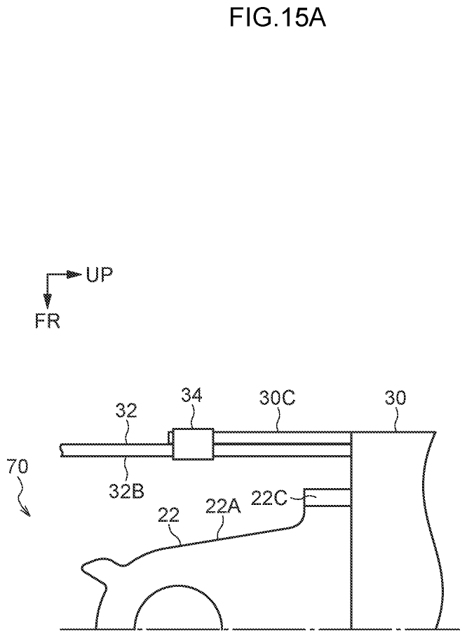

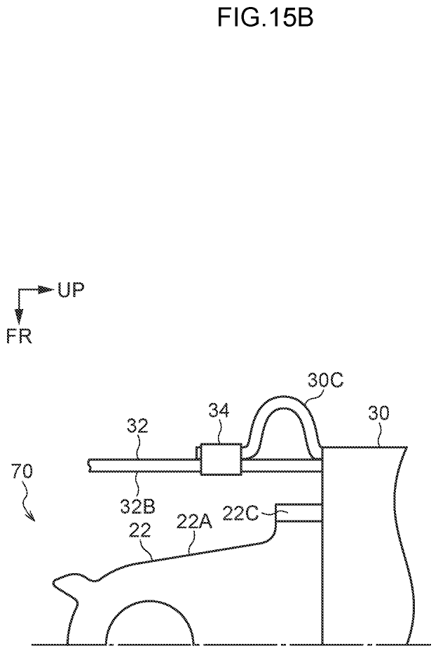

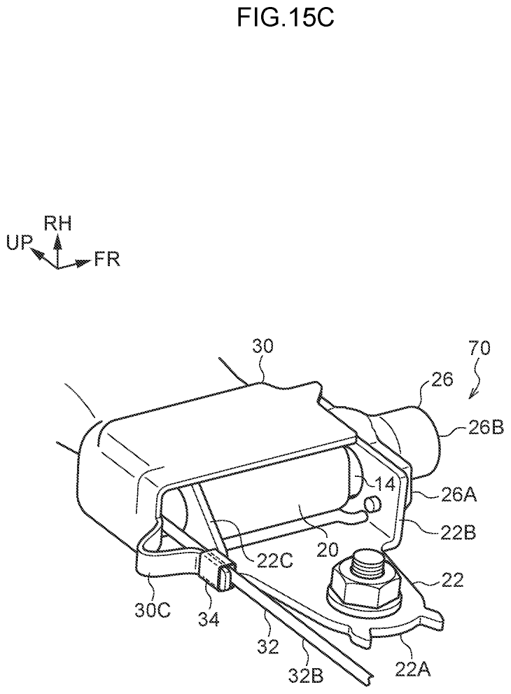

As illustrated in FIGS. 14 and 15A, in the buckle device 70 according to the embodiment, a boot 30 is not provided with an extension wall 30B.

A mounting plate 30C is integrally formed at an intermediate part of the rear wall of the boot 30 in the right-left direction. The thickness dimension of the proximal-end side part (upper side part) of a mounting plate 30C is not larger (made the same) than the thickness dimension of the distal-end side part lower side part of the mounting plate 30C, and the thickness of a part of the rear wall of the boot 30 in the vicinity of the mounting plate 30C is not larger. Therefore, the cross-sectional coefficient of the proximal-end side part of the mounting plate 30C and the cross-sectional coefficient of the distal-end side part of the mounting plate 30C are small, and the rigidity of the proximal-end side part of the mounting plate 30C and the rigidity of the distal-end side part of the mounting plate 30C are small.

In a case in which, at the time of light collision of a vehicle, a wire harness 32 is moved upward integrally with a buckle body 18, and the mounting plate 30C is elastically bent, the intermediate part of the proximal-end side part of the mounting plate 30C is bent while the proximal-end side end part of the distal-end side part of the mounting plate 30C and the proximal end part of the mounting plate 30C are bent (see FIGS. 15B and 15C).

Here, also in the embodiment, it is possible to exhibit the actions and effects similar to those of the first embodiment except for the action and effect obtained by making the rigidity of the proximal-end side part of the mounting plate 30C larger than the rigidity of the distal-end side part of the mounting plate 30C, and the action and effect obtained by providing the mounting plate 30C inside the boot 30 in the vehicle width direction, and the action and effect obtained by the extension wall 30B of the boot 30.

In the embodiment, the cross-sectional coefficient of the proximal-end side part of the mounting plate 30C is equal to the cross-sectional coefficient of the distal-end side part of the mounting plate 30C, and the rigidity of the proximal-end side part of the mounting plate 30C is equal to the rigidity of the distal-end side part of the mounting plate 30C. The cross-sectional coefficient of the proximal-end side part of the mounting plate 30C may be larger than the cross-sectional coefficient of the distal-end side part of the mounting plate 30C, and the rigidity of the proximal-end side part of the mounting plate 30C may be larger than the rigidity of the distal-end side part of the mounting plate 30C. In this case, a part of the rear wall of the boot 30 in the vicinity of the mounting plate 30C may have a large thickness similar to the proximal-end side part of the mounting plate 30C.

### Fifth Embodiment

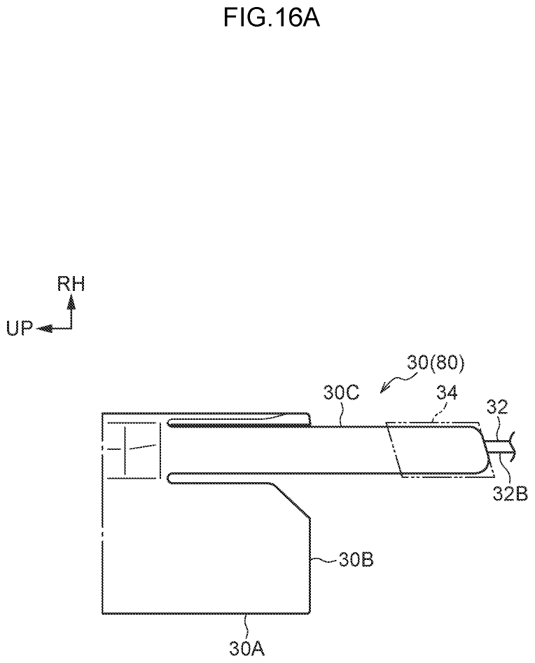

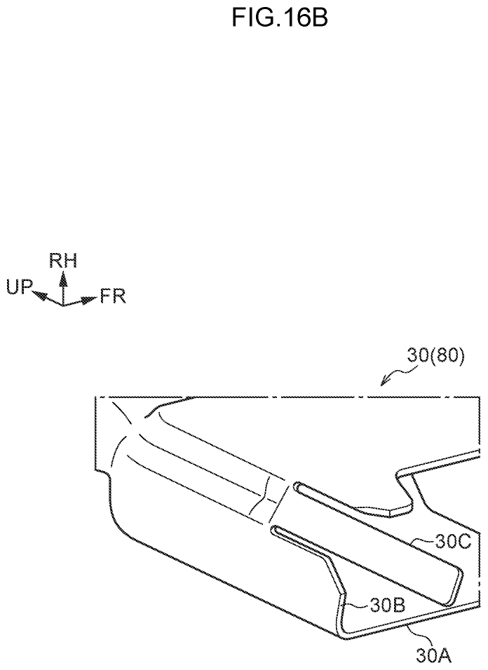

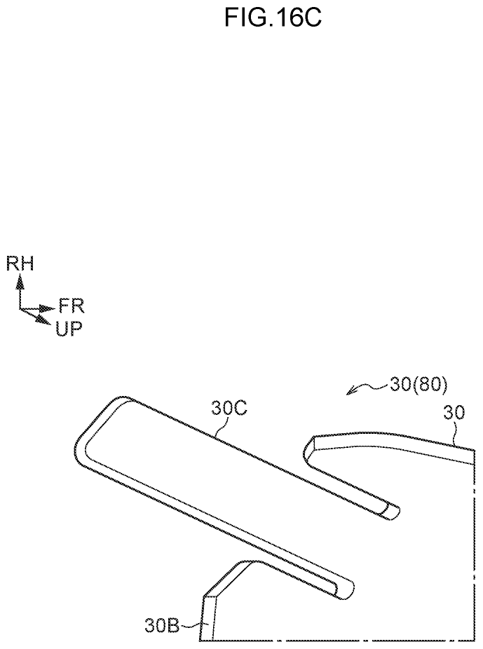

FIG. 16A is rear view illustrating a buckle device 80 according to a fifth embodiment of the invention as viewed from the rear. FIG. 16B is a perspective view illustrating the buckle device 80 as viewed from the rear side.

The buckle device 80 according to the present embodiment has substantially the similar configuration to the configuration of the first embodiment, but differs in the following points.

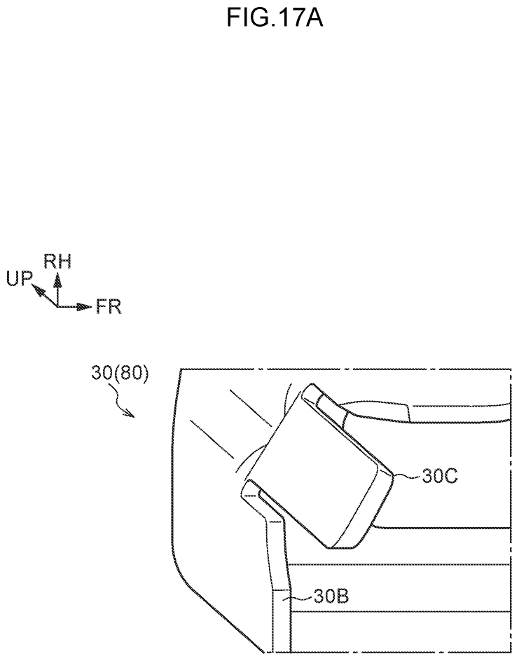

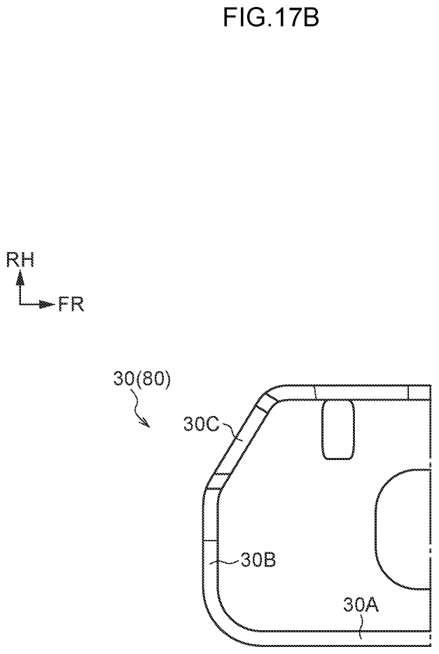

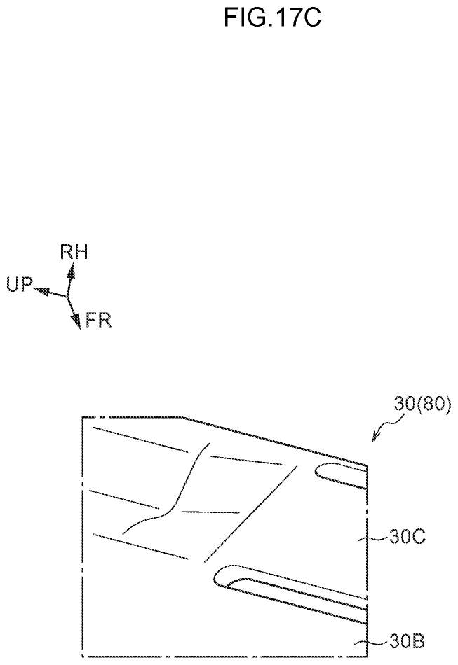

As illustrated in FIGS. 16A, 16B, 16C, 17A, 17B, and 17C, in the buckle device 80 according to the embodiment, a mounting plate 30C is integrally formed at a corner part between the right wall and the rear wall of a boot 30. The thickness dimension of the proximal-end side part (upper side part) of the mounting plate 30C is not larger (made the same) than the thickness dimension of the distal-end side part (lower side part) of the mounting plate 30C, and the thickness of a part of the corner part between the right wall and the rear wall of the boot 30 in the vicinity of the mounting plate 30C is not larger. Therefore, the cross-sectional coefficient of the proximal-end side part of the mounting plate 30C and the cross-sectional coefficient of the distal-end side part of the mounting plate 30C are small, and the rigidity of the proximal-end side part of the mounting plate 30C and the rigidity of the distal-end side part of the mounting plate 30C are small.

In a case in which, at the time of light collision of a vehicle, a wire harness 32 is moved upward integrally with a buckle body 18, and the mounting plate 30C is elastically bent, the intermediate part of the proximal-end side part of the mounting plate 30C is bent while the proximal-end side end part of the distal-end side part of the mounting plate 30C and the proximal end part of the mounting plate 30C are bent.

Here, also in the embodiment, it is possible to exhibit the actions and effects similar to those of the first embodiment except for the action and effect obtained by making the rigidity of the proximal-end side part of the mounting plate 30C larger than the rigidity of the distal-end side part of the mounting plate 30C, and the action and effect obtained by providing the mounting plate 30C inside the boot 30 in the vehicle width direction.

In the embodiment, the cross-sectional coefficient of the proximal-end side part of the mounting plate 30C is equal to the cross-sectional coefficient of the distal-end side part of the mounting plate 30C, and the rigidity of the proximal-end side part of the mounting plate 30C is equal to the rigidity of the distal-end side part of the mounting plate 30C. The cross-sectional coefficient of the proximal-end side part of the mounting plate 30C may be larger than the cross-sectional coefficient of the distal-end side part of the mounting plate 30C, and the rigidity of the proximal-end side part of the mounting plate 30C may be larger than the rigidity of the distal-end side part of the mounting plate 30C. In this case, the part of the corner part between the right wall and the rear wall of the boot 30 in the vicinity of the mounting plate 30C may have a larger thickness similar to the proximal-end side part of the mounting plate 30C.

In the first to fifth embodiments, the spool 24, the case 26, and the torsion shaft 28 are provided in the frame 22, and the belt 20 is coupled to the spool 24. The belt 20 may be coupled to the frame 22 without providing the spool 24, the case 26, and the torsion shaft 28 in the frame 22.

In the first to fifth embodiments, the deformation member is the torsion shaft 28. The deformation member may be a member other than the torsion shaft 28.

What is claimed is:

1. A buckle device comprising:
a buckle body configured to engage with a tongue provided at a webbing attached to an occupant;
a coupling member that is coupled to the buckle body and is extended by tension applied from the buckle body to extend the buckle body;
a support member that supports the buckle body and is provided with a mounting part; and
a wiring that is electrically connected to the buckle body, is mounted to the mounting part, the mounting part being elastically deformed and allowing the wiring to move in a case in which the buckle body is extended.

2. The buckle device according to claim 1, wherein the mounting part is elongated.

3. The buckle device according to claim 1, wherein a slack is provided at a part of the wiring between the buckle body and the mounting part.

4. The buckle device according to claim 1, wherein the mounting part is provided at a part of the support member on an inner side or an outer side in a vehicle width direction.

5. The buckle device according to claim 1, further comprising: an extension part that is configured to extend from the support member and is adjacent to the mounting part.

6. The buckle device according to claim 1, wherein rigidity of a proximal-end side part of the mounting part is higher than rigidity of a distal-end side part of the mounting part, and the wiring is mounted to the distal-end side part of the mounting part.

7. The buckle device according to claim 1, further comprising: a deformation member that is deformed in a case in which an extension load on the buckle body is equal to or more than a predetermined load, and allows the buckle body to extend.

8. The buckle device according to claim 1, wherein the mounting part is extended from the support member.

9. The buckle device according to claim 1, wherein a plurality of parts of the mounting part are bent in a case in which the mounting part is elastically deformed.

10. The buckle device according to claim 1, wherein a slack is provided at a part of the wiring between the buckle body and the mounting part, and an amount that the wiring can move due to the slack is more than an amount that the wiring can move due to elastic deformation of the mounting part.
